(19) United States
(12) Patent Application Publication
(10) Pub. No.: US 2014/0149213 A1
(43) Pub. Date: May 29, 2014

(54) APPARATUS AND METHOD FOR GENERATING PERSONALIZED INFORMATION AND PROMOTING ONLINE ADVERTISING IN A SOCIAL NETWORK

(71) Applicant: Eyad A. Fallatah, Chicago, IL (US)

(72) Inventor: Eyad A. Fallatah, Chicago, IL (US)

(21) Appl. No.: 13/684,277

(22) Filed: Nov. 23, 2012

(51) Int. Cl. G06Q 30/02

(52) U.S. Cl. CPC G06Q 30/0255
USPC 705/14.53

(57) ABSTRACT

An information processing apparatus and associated methodology for generating personalized fashion-related information and promoting online advertising in a social network. The personalized fashion-related information includes personalized fashion style suggestions, recommended fashion items to purchase, customized advertising, and recommended vendors for each of the recommended fashion items to purchase. The information processing apparatus generates the personalized fashion information based on the profile and history information of a user and weather information where the user is located. With respect to a purchase transaction, the information processing apparatus creates a unique identification number and assigns to the transaction, thereby a buyer conveniently uploads purchased items to the social network.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

As online social networks are gaining increasing popularity in recent years, people around the globe have become able to easily communicate with each other without being limited by location, time, and language. Via social network sites like Facebook®, people often share not only factual information but also personal interests and preferences such as fashion accessories and cooking recipes. In particular, fashion items tend to be trendy and change rapidly and people frequently search for recent information or advice from other members of the social network site. In addition, people are influenced by the opinions of other peers of similar age or interest when they make a purchasing decision on fashion items.

Meanwhile, information available in such a traditional social network is voluminous and unfiltered such that information readily available is not tailored to a specific need of a member who actively seeks personalized information. Further, members may find themselves inundated with undesired commercial offers and unable to find in a timely and efficient manner the information they want. Similarly, manufacturers and retailers of fashion items often find themselves having difficulty in finding and reaching out to potential consumers interested in their products and end up wasting their resources on inefficient advertising. Accordingly, there is a need for an apparatus and associated method for generating personalized information for members and promoting online advertising for businesses in a social network.

### SUMMARY OF THE INVENTION

The present invention describes an information processing apparatus and associated methodology for generating personalized information and promoting online advertising in a social network.

In selected embodiments, the information processing apparatus provides a social network environment in which users of the social network interact with other users and build relationships with each other. In particular, the information processing apparatus provides a social network in which users of the social network share information on fashion-related information with each other and dynamically suggest fashion items to wear and purchase as the users socialize. Further, the social network generates personalized fashion-related information and delivers it to each user. This personalized fashion-related information includes personalized fashion style suggestions, recommended fashion items to purchase, customized advertising, and recommended vendors for each of the recommended fashion items to purchase.

In an exemplary embodiment, the information processing apparatus includes a user database, a purchase database, and a history database. The user database stores profile information of one or more users of the social network and relationship data between each user and followers of the each user. The purchase database stores purchase information of each user in correspondence with respective profile information of the each user. The history database stores history information of each user including a purchase history from the purchase database.

In response to a purchase made off-line in a vendor store or via an online vendor store by a user of the social network, the social network obtains purchase information by receiving a post-purchase approval from the user and saves the purchase information in the purchase database. When the purchase is made off-line in a vendor store, the post-purchase approval is performed by way of receiving an identification number or a barcode being scanned via a mobile device and, when the purchase is made via an online vendor store, the post-purchase approval is performed by way of a link being clicked, the link having been sent by the purchase database.

In an exemplary embodiment, the information processing apparatus generates the personalized fashion information based on the profile and history information of the user and weather information where the user is located. The profile information includes at least age, gender, body measurements, a budget, and a geographic location of the user. The history information includes at least purchase history, a history of viewed items, a history of preferred vendors, and a history of preferred brands.

In an exemplary embodiment, the information processing apparatus conducts a search via network sites other than the social network of the present invention, for example Twitter® and Yahoo®, to find new followers when the number of the received styling suggestions from the followers of the user is less than a predetermined threshold.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a social network according to an exemplary embodiment;

FIG. 2 is a schematic diagram of an information processing apparatus according to an exemplary embodiment;

FIG. 3 is an illustrative programming layout of the social network according to an exemplary embodiment;

FIG. 4 is an algorithmic flow chart showing the process of posting a fashion recommendations request to followers in the social network according to an exemplary embodiment;

FIG. 5 is an algorithmic flow chart showing the overall process of generating personalized fashion style suggestions in the social network according to an exemplary embodiment;

FIG. 6 illustrates an exemplary algorithm implemented by the information processing apparatus for generating personalized fashion style suggestions in the social network according to an exemplary embodiment;

FIG. 7 illustrates an exemplary algorithm implemented by the information processing apparatus for generating customized advertising in the social network according to an exemplary embodiment;

FIG. 8 is an algorithmic flow chart showing the process of uploading items purchased off-line in a store to the purchase database of the information processing apparatus according to an exemplary embodiment;

FIG. 9 is an algorithmic flow chart showing the process of uploading items purchased off-line in a store to the purchase database of the information processing apparatus according to an exemplary embodiment;

FIG. 10 shows an illustrative receipt with a QR code and a unique identification number printed on the receipt according to an exemplary embodiment;

FIG. 11 is an algorithmic flow chart showing the process of uploading items purchased in an online store to the social network according to an exemplary embodiment;

FIG. 12 is an algorithmic flow chart showing the process of uploading items purchased in an online store to the social network according to an exemplary embodiment;

FIG. 13 shows an illustrative electronic receipt with a unique link on the receipt according to an exemplary embodiment;

FIG. 14 is an algorithmic flow chart showing the process of finding friends or followers in the social network according to an exemplary embodiment;

FIG. 15 is an algorithmic flow chart showing the process of finding friends or followers in the social network according to an exemplary embodiment; and

FIG. 16 is a schematic diagram for hardware of the information processing apparatus according to an exemplary embodiment.

### DETAILED DESCRIPTION OF THE EMBODIMENTS

Referring now to the drawings, wherein like reference numerals designate identical or corresponding parts throughout the several views.

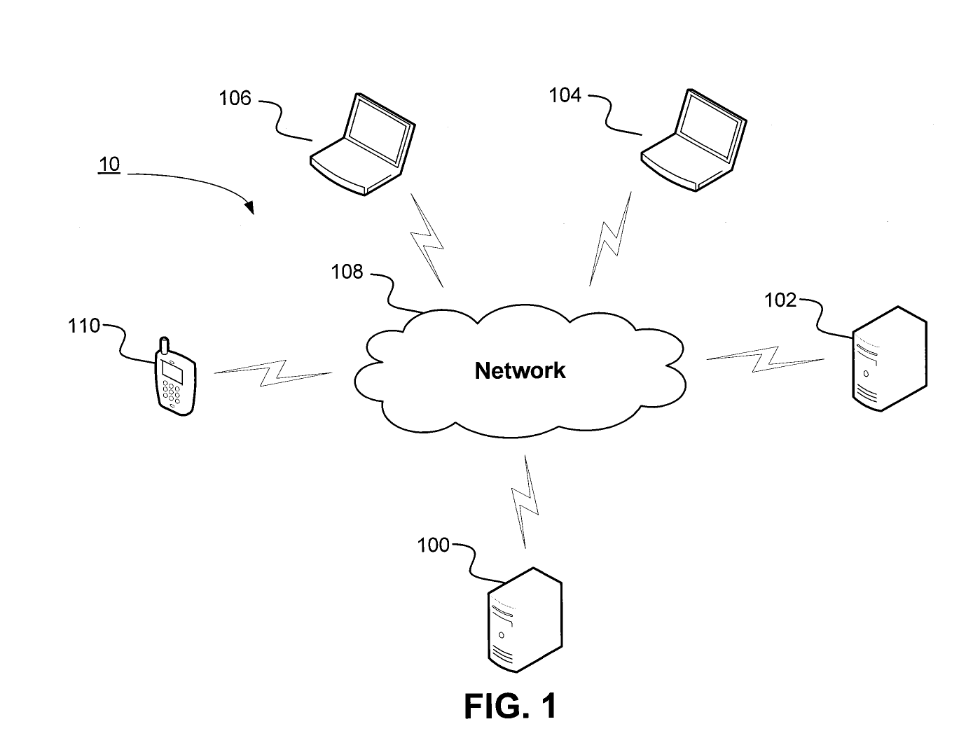

FIG. 1 is a schematic diagram of a social network 10 according to an exemplary embodiment. In FIG. 1, an information processing apparatus 100 is connected to a server 102, an authorized user 104, an unauthorized user 106, and a mobile device 110 via a network 108. The server 102 represents one or more servers connected to the information processing apparatus 100, the authorized user 104, the unauthorized user 106, and the mobile device 110 via the network 108. The authorized user 104 represents one or more authorized user machines connected to the information processing apparatus 100, the server 102, the unauthorized user 106, and the mobile device 110 via the network 108. The unauthorized user 106 represents one or more unauthorized user machines connected to the information processing apparatus 100, the server 102, the authorized user 104, and the mobile device 110 via the network 108. The mobile device 110 represents one or more mobile devices connected to the information processing apparatus 100, the server 102, the authorized user 104, and the unauthorized user 106 via the network 108. The network 108 represents one or more networks, such as the Internet, connecting the information processing apparatus 100, the server 102, the authorized user 104, the unauthorized user 106 and the mobile device 110. According to an exemplary embodiment, the network 108 may include the Internet, an intranet, a local area network (LAN), a wide area network (WAN), a wireless network and/or the like.

In the exemplary embodiment, the information processing apparatus 100 may store critical information such as users' data and information processing algorithms separately in a server 102 such that the information is protected from being accessed by unauthorized user 106. The information processing apparatus 100 may process one or more tasks independently or in parallel with the server 102.

The information processing apparatus 100 of the present invention provides a social network 10 environment in which a user of the social network 10 interacts with other users to build relationships with each other. Anyone who provides personal information required by the social network 10 and agrees to the terms and conditions set by the social network 10 becomes an authorized user (hereinafter “user”) of the social network 10. A user can have friends or followers among other users who are allowed to receive an update from the user upon request from other user and subsequent approval by the user. A user can upload or download data, communicate with other users (also called “socialize”), share data with each other and so on. However, the functions or services available in the social network 10 according to an exemplary embodiment of the present invention is not limited to the aforementioned ones and may include other functions or services commonly available in a social network site, as would be understood by one of ordinary skill in the art.

In particular, the information processing apparatus 100 provides the social network 10 in which users of the social network 10 share information on fashion-related information and dynamically suggest fashion items to wear and purchase to each other as the users socialize. Further, the information processing apparatus 100 generates personalized fashion-related information and delivers it to each user. This personalized fashion-related information includes personalized fashion style suggestions, recommended fashion items to purchase, customized advertising, and recommended vendors for each of the recommended fashion items to purchase.

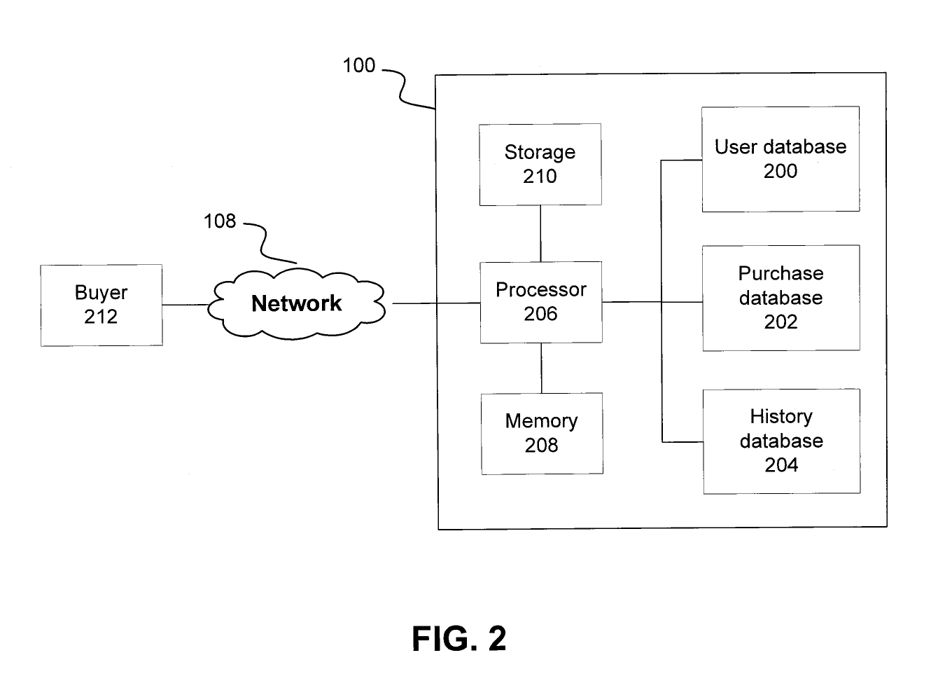

FIG. 2 is a schematic diagram of an information processing apparatus 100 according to an exemplary embodiment. In exemplary embodiments, the information processing apparatus 100 may be implemented as a server such as an IBM Blade® server. The information processing apparatus 100 includes a user database 200, a purchase database 202, a history database 204, a processor 206, a memory 208, and a storage 210. In selected embodiments, the databases 200, 202, 204 may be included in an external server and accessed by the information processing apparatus 100. The user database 200 stores profile information of one or more users of the social network 10. The profile information may include at least age, gender, body measurements, a budget, and a geographic location of each user. A unique user ID is assigned to each user to identify an individual user. The user database 200 also stores relationship data between each user and followers of the each user. The purchase database 202 stores purchase information of each user, i.e. buyer 212, in correspondence with respective profile information identified by user ID. The purchase information may include at least user ID, a description of a purchased item, a brand name, a vendor name, and a geographic location and weather information where the purchase is made. The history database 204 stores information on a history of each user. The history information may include at least user ID, a history of purchased items and corresponding purchase information, a history of viewed items, a history of preferred vendors, and a history preferred brands. The processor 206 is configured to execute one or more programs stored in the storage 210 to receive, process, and save data from users of the social network 10 and to process the methods described herein. During execution, the memory 208 stores temporary data that is being read, processed, or saved by the processor 206.

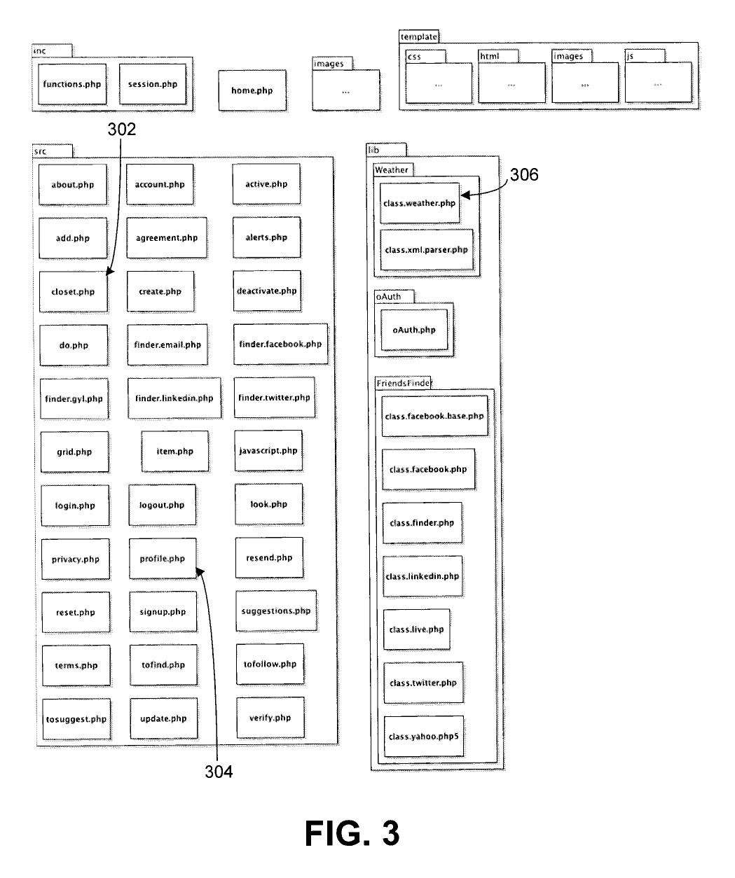

FIG. 3 is an illustrative programming layout of the social network 10 according to an exemplary embodiment. An individual box represents each class performing a different task in the social network 10. For example, “closet.php” 302 represents a class that receive and save purchased items of each user in a place called virtual closet within the history database 204. “Profile.php” 304 represents a class that receive profile information from a user and save it in the user database 200. In selected embodiments, when information on purchased items are received from a user after a purchase is made, user ID of the user who made the purchase is identified in cooperation with “profile.php” 304 and the information on purchased items is subsequently saved with respect to the identified user ID in an individual virtual closet in cooperation with “closet.php” 302. For another example, “class.weather.php” 306 represents a class that searches for current weather information where a user is currently located when such a search is requested. Operation of the social network 10 will be explained in detail later.

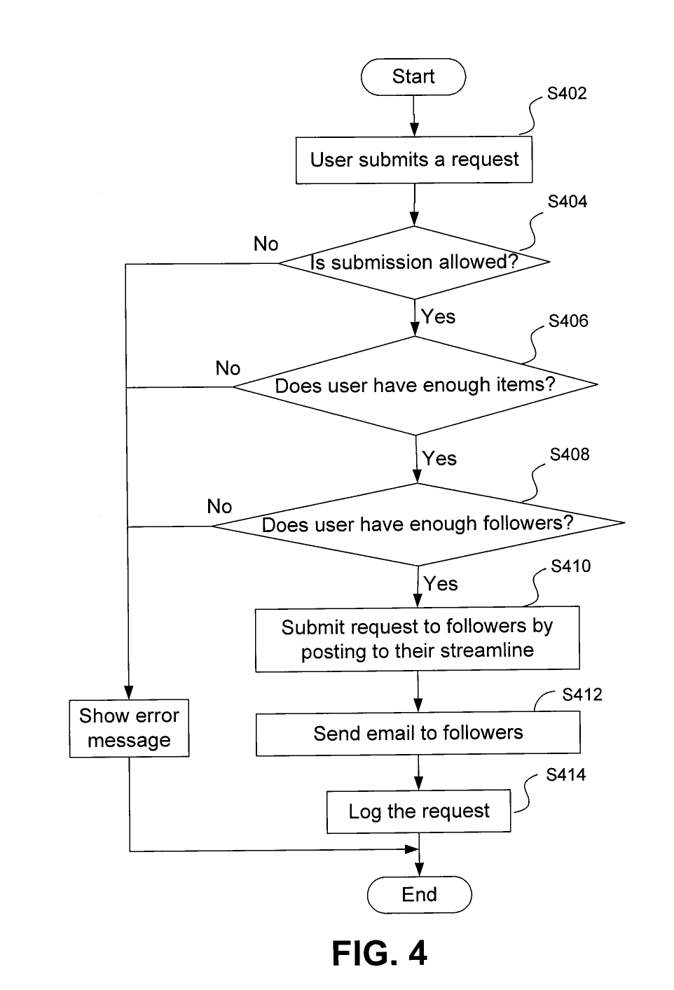

FIG. 4 is an algorithmic flow chart showing the process of posting a fashion recommendations request to followers in the social network 10 according to an exemplary embodiment. In an exemplary embodiment, a user of the social network 10 submits a request to the followers of the user to receive fashion recommendations from them. For example, the fashion recommendations may include colors of sweater, recommended brands for women's purse, and a design of a certain neck-tie. However, the fashion recommendations is not limited to the aforementioned information and may be any information related to the fashion items. When a user submits a fashion recommendation request (S402) to the social network 10, the information processing apparatus 100 checks if the submission of the request is allowed for the requester at step S404. When the submission is allowed, the process proceeds to step S406. Otherwise, the process shows an error message and ends. For example, when the request is not related to fashion items, the submission may not be allowed. Step S406 checks if the requester has a predetermined threshold amount of items in the individual virtual closet. When the number of items exceeds the predetermined threshold, for example twenty or more items previously purchased, the process continues to step S408. Otherwise, the process shows an error message and ends. Next, step S408 checks if the requester has a predetermined threshold amount of followers, for example ten or more followers. When the number of followers exceeds the predetermined threshold, the process moves on to step S410. Otherwise, the process shows an error message and ends. In selected embodiments, when the number of followers does not exceed the predetermined threshold, the information processing apparatus 100 may search for friends (or followers) via other available social network sites or using other methods, which will be explained in detail later. At step S410, the information processing apparatus 100 submits the received request to the followers by posting to the respective streamline of each follower. The information processing apparatus 100 may inform each follower that a new request has been posted to his or her profile by sending an email to each follower (S412). The process logs the request to the history database 204 (S414) and ends.

Upon receiving a fashion recommendations request from a user, each follower may provide appropriate recommendations to the user by uploading his or her recommendations to the request. For example, in response to a recommendations request for “what kind of neck tie goes well with my black suit for a job interview?,” followers' recommendations may include, for example, a design, a color, a specific brand, and a retailer for a certain necktie.

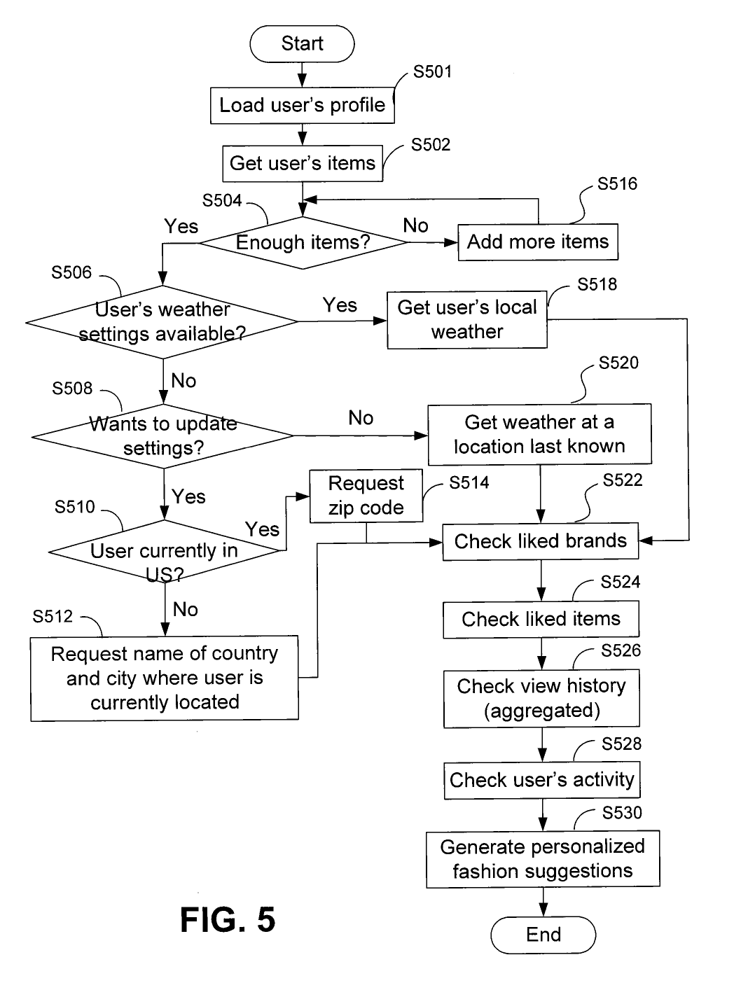

In an exemplary embodiment, the information processing apparatus 100 makes personalized fashion style suggestions to users of the social network 10. The suggestions may be made on a regular basis such as daily or on a special occasion basis such as birthday or anniversary or at a predetermined interval set by the user. FIG. 5 is an algorithmic flow chart showing the overall process of generating personalized fashion style suggestions in the social network according to an exemplary embodiment. The process starts by loading user's profile information (S501) and getting user's fashion items from the virtual closet of the user (S502). When enough fashion items are obtained (S504), for example twenty or more items, the process moves on to step S506. When enough fashion items are not obtained, the information processing apparatus 100 attempts at step S516 to obtain more items from the user to add to the virtual closet based on potential purchases known to the user but unknown to the social network 10 and returns to step S504. Next, the process checks if the user's weather settings are available at step S506. When the user's weather settings are available, the process gets a user's current local weather (S518) and proceeds to step S522. When the user's weather settings are not available, the process asks the user if the user wants to update the weather settings (S508). When yes, the process asks if the user is currently located in the U.S. or abroad (S510). In case the user is currently located in the U.S., the process requests a zip code (S514) and moves on to step S522. When the user is currently located abroad, the process requests the name of country and city where the user is currently located (S512) and proceeds to step S522. Further, GPS or other geo-synchronous information of the user can also be used. When the user's geographic information is not available, the information processing apparatus 100 determines the current location of the user based on the information available in the history database 204 of the user, for example a location last known, and obtains current weather information at this location (S520) and proceeds to step S522. Subsequently, the process checks various user's history information saved in the history database 204. In an exemplary embodiment, the user's history information may include the brands the user liked (S522), the fashion items the user liked or purchased (S524), a view history on fashion items (S526), the activities the user joined (S528). This user's history information collectively represents the user's shopping preferences. Based on the user's profile information, the current weather information where the user is located, and the user's purchase history information, the process runs one or more algorithms to generate personalized fashion style suggestions for the user at step S530.

The user's profile information used to generate the personalized fashion style suggestions may include at least age, gender, race, geographic location, and body measurements of the user. However, the system is not limited to these parameters. In addition, the algorithms generate customized advertising to the user along with the personalized fashion style suggestions. The generated personalized fashion style suggestions and customized advertising are delivered and displayed to the user in various formats using table, picture, or animated figure.

As briefly discussed above, the information processing apparatus 100 generates personalized fashion style suggestions based on various information obtained such as a user's profile information, local weather information, purchase history information, and fashion recommendations from one or more followers of the user. An exemplary explanation how the information processing apparatus 100 operates to generate personalized fashion style suggestions is provided below. First, the information processing apparatus 100 may check if a user is male or female from the user's profile information. Next, assume, among various fashion items, that the information processing apparatus 100 is about to suggest clothing as fashion style suggestions for the user on a certain day. Clothing may be selected as a suggested item because different kinds of fashion items such as accessories and shoes were suggested over past couple of days for example. To determine a category of clothing to be suggested, the information processing apparatus 100 may check a local weather of the user. Depending on the local weather, the information processing apparatus 100 may suggest, for example, a coat or winter pants for a cold day in winter, short pants or half sleeve shirt for a hot day in summer, and a sweater or jacket for a mild day in fall. Assuming a mild day in fall, the information processing apparatus 100 might narrow the selection down to either sweater or jacket. Next, the information processing apparatus 100 may check previously purchased items in the user's virtual closet with regard to, for example, which item the user prefers, which item the user purchased most recently, how many of each item the user has purchased. Assuming that the user never purchased a sweater over past 3 years, the information processing apparatus 100 may finally select sweater as an item to be suggested for that day and subsequently determines a color of sweater based on the past purchases from the virtual closet. Upon completion of selection, the information processing apparatus 100 suggests the selected item, for example yellow sweater, to the user as personalized fashion style suggestions of that day. In addition, the information processing apparatus 100 may recommend the selected item (e.g. yellow sweater) for purchase.

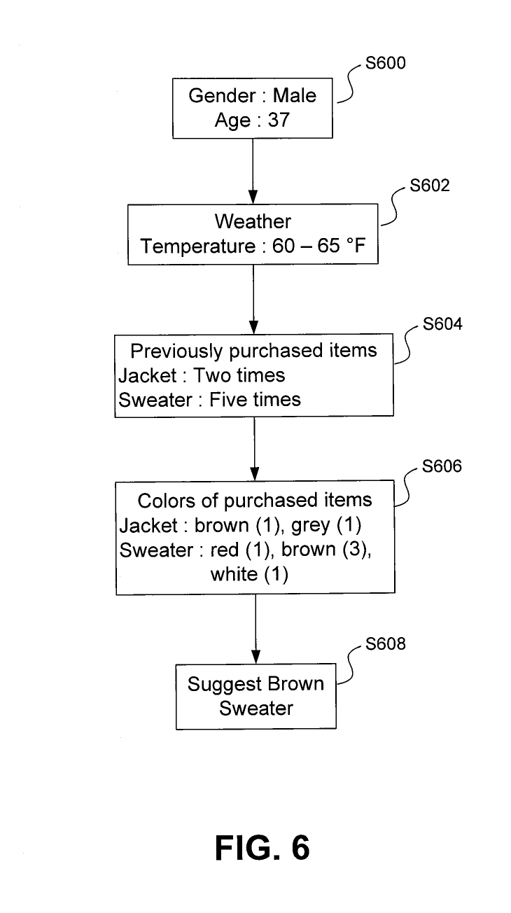

FIG. 6 illustrates an exemplary algorithm implemented by the information processing apparatus 100 for generating personalized fashion style suggestions in the social network 10 according to an exemplary embodiment. For purpose of explanation and for one illustrative example, assume that the information processing apparatus 100 is currently in process of generating personalized fashion style suggestions for a user on a certain day in fall. First, the process loads profile information of the user, which includes gender (“Male”) and age (“37”) of the user (S600). The process then reads current weather information where the user is located, which may include current temperature (“60-65° F.”) at step S602. Based on this information, the algorithm may come up with the following two fashion items, for example jacket and sweater as a candidate for suggestions of that day. Next, the process checks a previous purchase history of the user with regard to jacket and sweater and finds that the user purchased jacket twice and sweater five times in the past (S604). That is, the user previously purchased more sweaters than jackets. Subsequently, the process checks which colors the user preferred and finds that the user's favorite color is brown (S606). Based on the aforementioned information, the algorithm generates “Brown Sweater” as the fashion style suggestions of the day at step S608.

Further, in an exemplary embodiment, the information processing apparatus 100 makes a recommendation on fashion items to purchase. For example, referring back to FIG. 6, the information processing apparatus 100 may recommend one or more brown sweaters from different vendors to the user. The generated personalized fashion style suggestions and/or recommended fashion items for purchase are delivered and displayed to the user in various formats using table, picture, or animated figure.

In an exemplary embodiment, the information processing apparatus 100 generates customized advertising based on various information obtained such as a user's profile information, local weather information, purchase history information, and fashion recommendations from one or more followers of the user. An exemplary explanation how the information processing apparatus 100 operates to generate customized advertising is provided below. First, the information processing apparatus 100 may check if a user is male or female from the user's profile information. Next, assume, among various fashion items, that the information processing apparatus 100 is about to advertise clothing for the user on a certain day. Clothing may be selected as an item to be advertised because different kinds of fashion items such as accessories and shoes were advertised over past couple of days for example. To determine a category of clothing to be advertised, the information processing apparatus 100 may check a local weather of the user. Depending on the local weather, the information processing apparatus 100 may provide advertising on, for example, a coat or winter pants for a cold day in winter, short pants or half sleeve shirt for a hot day in summer, and a sweater or jacket for a mild day in fall. Assuming a mild day in fall, the information processing apparatus 100 might narrow the selection down to either sweater or jacket. Next, the information processing apparatus may check previously purchased items in the user's virtual closet with regard to, for example, which item the user prefers, which item the user purchased most recently, how many of each item the user has purchased. Assuming that the user never purchased a sweater over past 3 years, the information processing apparatus 100 may finally select sweater as an item to be advertised for that day and subsequently determines a color of sweater based on the past purchases from the virtual closet. Upon completion of selection, the information processing apparatus 100 may inform one or more vendors that the user might be interested in purchasing the determined item, for example yellow sweater. The information processing apparatus 100 may also transmit related fashion style suggestions having been presented to the user to the vendors. Subsequently, the vendors may offer appropriate advertising to the user via the social network 10. This customized advertising is delivered and displayed to the user in various formats using table, picture, or animated figure.

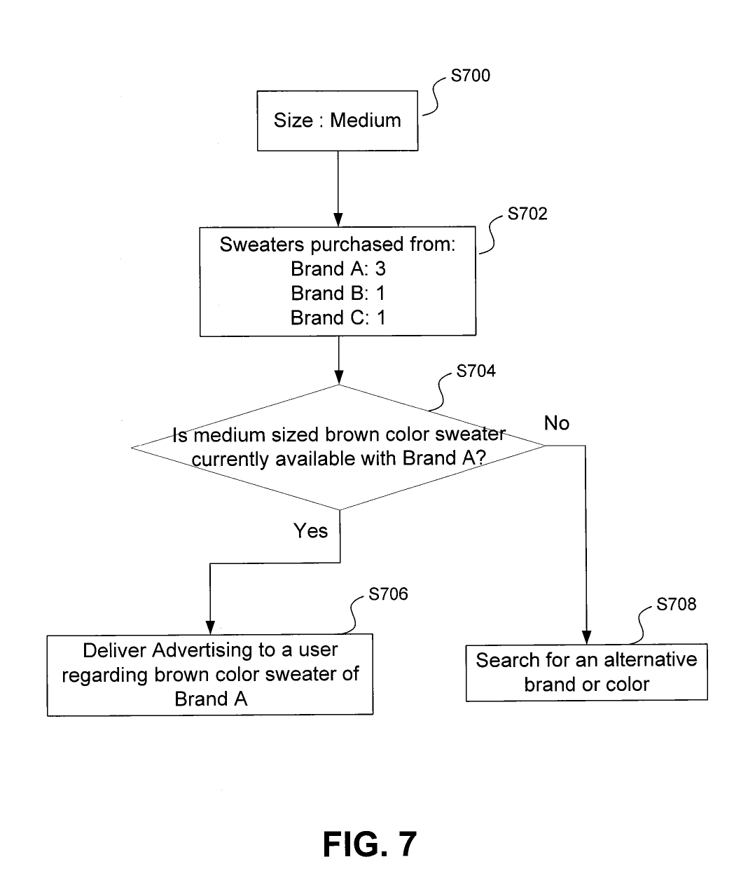

FIG. 7 illustrates an exemplary algorithm implemented by the information processing apparatus 100 for generating customized advertising in the social network 10 according to an exemplary embodiment. For purpose of explanation and for one illustrative example, assume that the algorithm of FIG. 6 has determined brown sweater as the fashion style suggestions of the day. Next, the algorithm checks the body size (“Medium”) of the user at step S700 of FIG. 7. The process then checks which brand of sweaters the user preferred in the past and finds that Brand A is his or her favorite brand (S702). Next, the process checks if sweater of brown color is currently available with Brand A (S704). When yes, the information processing apparatus 100 delivers advertising on brown sweater of Brand A to the user (S706). Otherwise, the process proceeds to search for brown sweater of an alternative brand or sweater of an alternative color of Brand A (S708).

According to an exemplary embodiment, once a fashion item to recommend to the user, like “brown sweater,” is determined, the information processing apparatus 100 informs one or more vendors from which the user might be interested in purchasing a brown sweater and promotes online advertising from vendors by transmitting the recommendation to subscribing vendors. Subsequently, vendors may offer appropriate advertising to the user via the social network 10 and this offer may further lead to user's purchase of the advertised product. In this process, the user's identity and personal information are securely protected because the social network 10 does not share any user's profile information with advertisers or vendors.

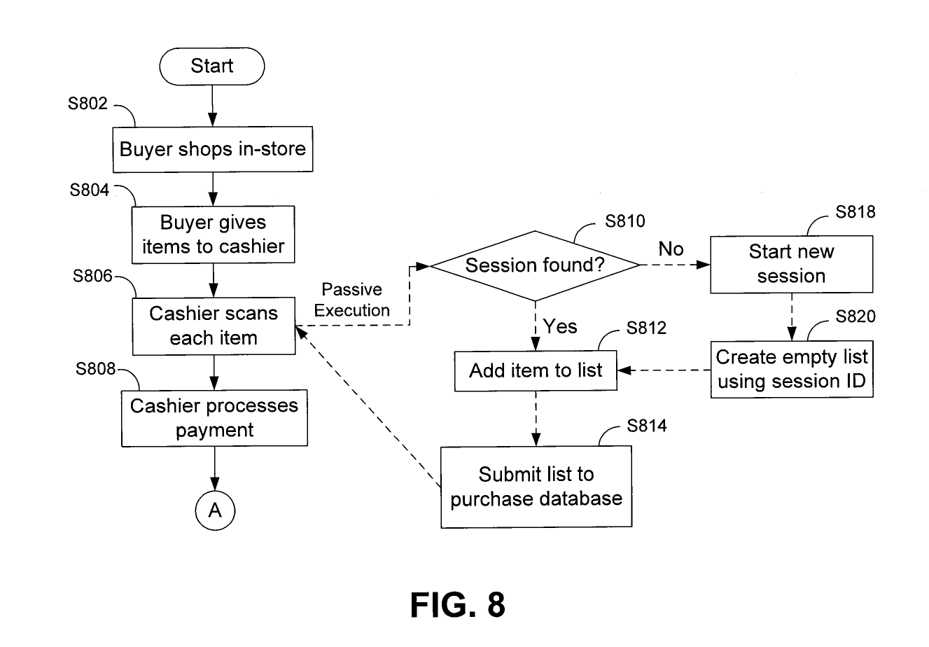

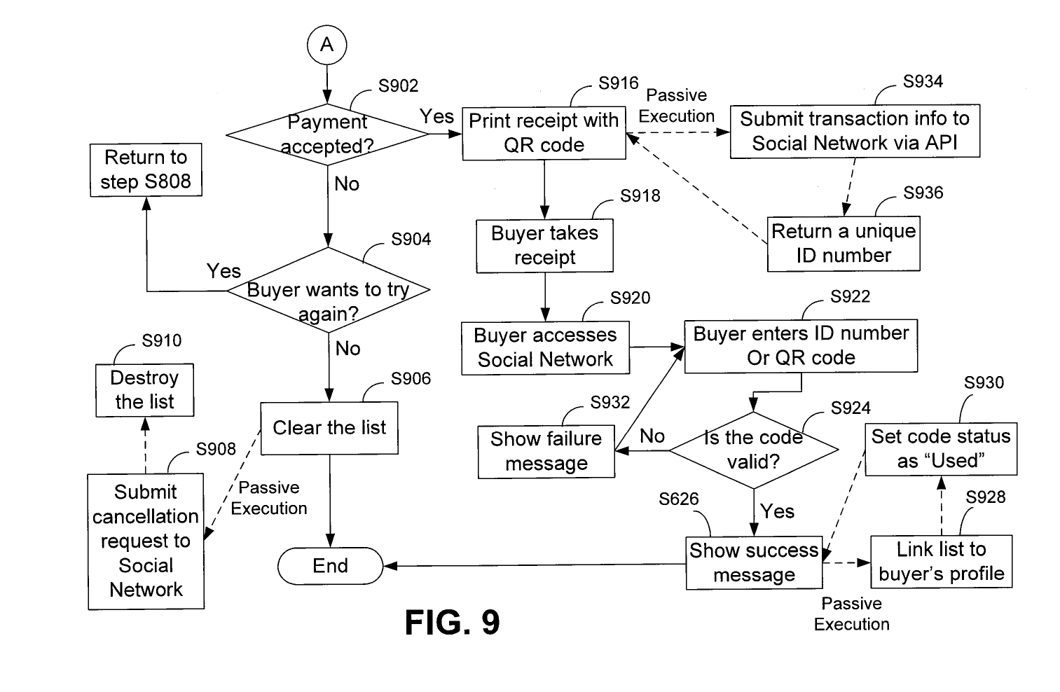

FIGS. 8 and 9 are algorithmic flow charts showing the process of uploading items purchased off-line in a store to the purchase database 202 of the information processing apparatus 100 according to an exemplary embodiment. Referring to FIG. 8, a user (or buyer) of the social network 10 shops in a store (S802) which is a member store of the social network 10 and gives fashion items to be purchased to a cashier (S804) so that the cashier can scan the items. The cashier completes scanning the items (S806) and proceeds to process payment (S808). Upon completing scanning, the member store's system checks if a session has been created for the buyer regarding the items to be purchased on that day (S810). If yes, the member store's system adds the items to be purchased to the list of the session found (S812). If no session is found, the system starts a new session (S818), creates an empty list using the new session ID (S820), and adds the items to be purchased to the created list (S812). Subsequently, the system submits the list to the purchase database 202 of the information processing apparatus 100 via an Application Program Interface (hereinafter API) at step S814. This process occurring between the member store's system and the social network 10 is indicated as “Passive Execution” along with the dotted lines as shown in FIGS. 8 and 9. The list sent to the purchase database 202 via API may include, for example, description of the purchased items (e.g. item name, brand name, color, important features), price of the items, and a retailer's information.

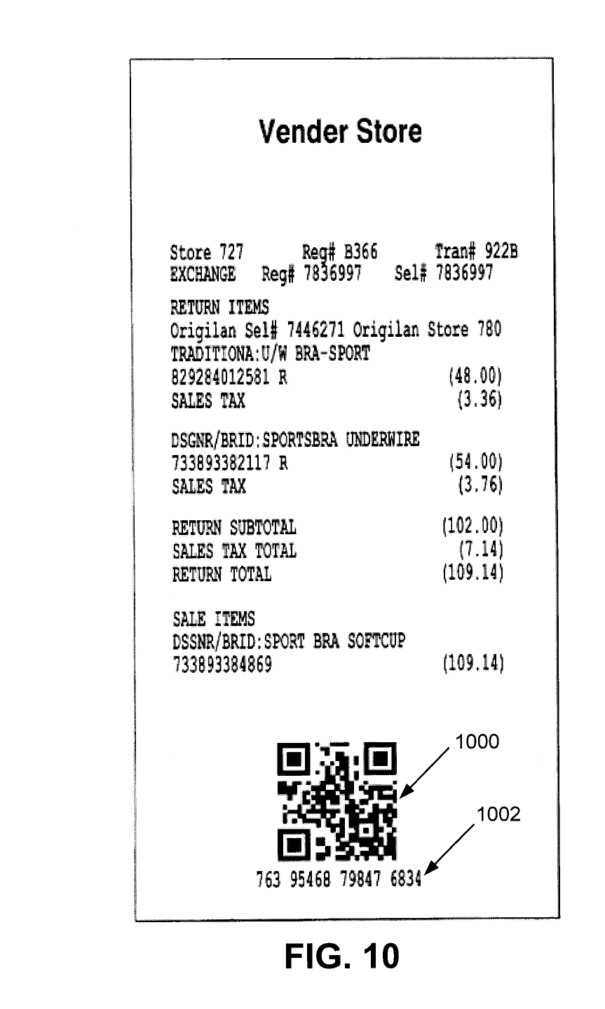

Referring to FIG. 9, in continuation from step S808 of FIG. 8, when the payment is accepted (S902), the store's system simultaneously submits transaction information to the social network system 10 via API (S934) and the database engine of the information processing apparatus 100 assigns a unique identification number to the transaction (S936). Subsequently, the cashier prints a receipt with a QR code (or bar code) having the assigned unique identification number printed below the QR code at step S916. The QR code associated with the unique identification number is linked to the purchase information such that the purchase information can later be accessed via either the QR code or the unique identification number. FIG. 10 shows an illustrative receipt with a QR code and a unique identification number printed on the receipt according to an exemplary embodiment. At the bottom of the receipt shown in FIG. 10, there is a QR code 1000 printed and an identification number 1002 below the QR code 1000, which is uniquely created to a transaction. Referring back to FIG. 9, when the payment is not accepted at step S902, the cashier checks if the buyer wants to try again with payment (S904). If yes, the process goes back to step S808. Otherwise, the process clears the list (S906) and ends, and the store's system simultaneously submits a cancellation request to the social network 10 (S908) and the information processing apparatus 100 then destroys the list previously submitted by the store's system (S910). Returning to step S916, the buyer takes the printed receipt from the cashier (S918). After the shopping in the store, the buyer accesses the social network 10 (S920) and either enters the identification number printed on the receipt or scans the QR code on the receipt via a device such as smart phone. The information processing apparatus 100 checks if the submitted identification number or QR code is valid at step S924. If valid, the information processing apparatus 100 shows a success message (S926) and ends the process. At the same time, the list of purchased items is linked to the buyer's profile at step S928 and saved in the purchase database 202 updating the buyer's virtual closet, and the QR code status is set as “used.” If the submitted identification number or QR code is not valid at step S924, the information processing apparatus 100 shows a failure message (S932) and returns to step S922.

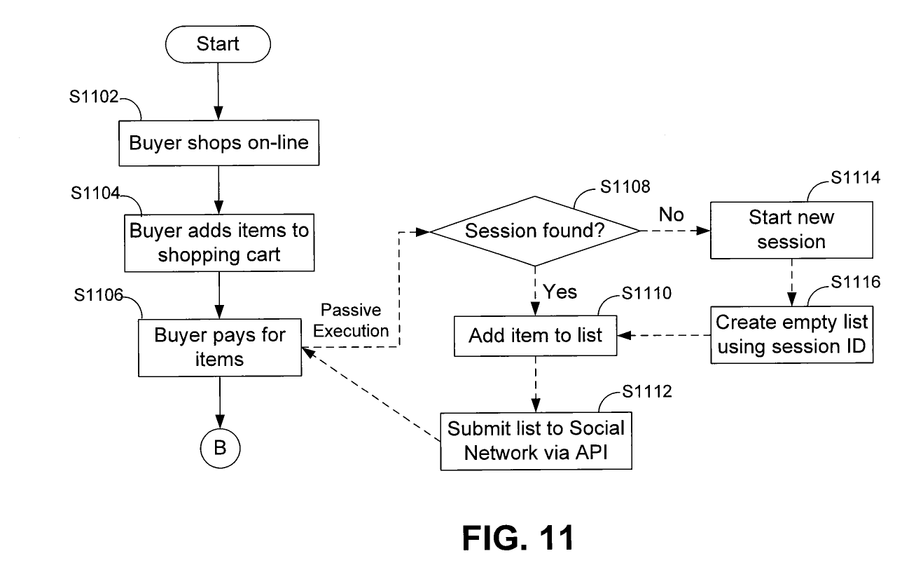

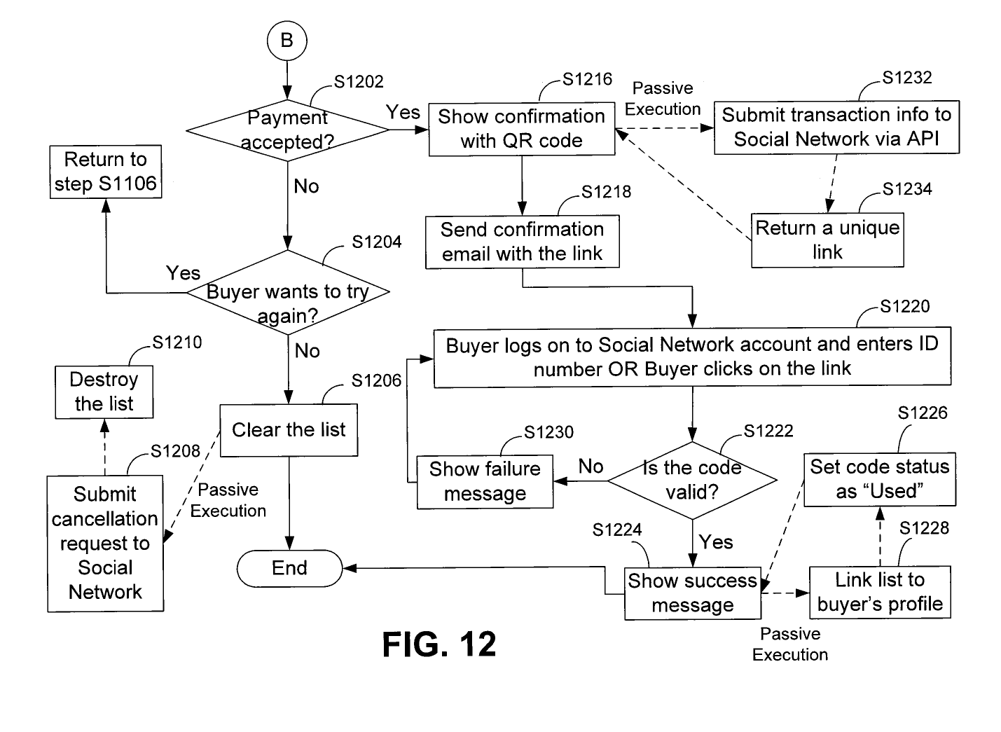

FIGS. 11 and 12 are algorithmic flow charts showing the process of uploading items purchased in an online store to the social network 10 according to an exemplary embodiment. Referring to FIG. 11, a user (or buyer) of the social network 10 shops in an online member store of the social network 10 (S1102) and adds fashion items to be purchased to a shopping cart (S1104). Upon completion of adding fashion items, the buyer proceeds to make a payment (S1106). On the other hand, as soon as the buyer initiates the payment process, the online member store's system checks if a session has been created for the buyer regarding the items to be purchased on that day at step S1108. If yes, the member store's system adds the items to be purchased to the list of the session found (S1110). If no session is found, the system starts a new session (S1114), creates an empty list using the session ID (S1116), and adds the items to be purchased to the created list (S1110). Subsequently, the system submits the list to the social network 10 via API at step S1112. This process occurring between the member store's system and the social network 10 is indicated as “Passive Execution” along with the dotted lines in FIGS. 11 and 12.

According to an exemplary embodiment, in case of online shopping, the information processing apparatus 100 generates a unique link associated with a transaction made in an online store. This unique link is linked to purchase information to be uploaded to the purchase database 202. The information processing apparatus 100 sends the buyer a confirmation email with the unique link attached to the confirmation email. Subsequently, the buyer can easily upload purchased items to the purchase database 202 by merely clicking on the unique link received (i.e. via activation of the unique link).

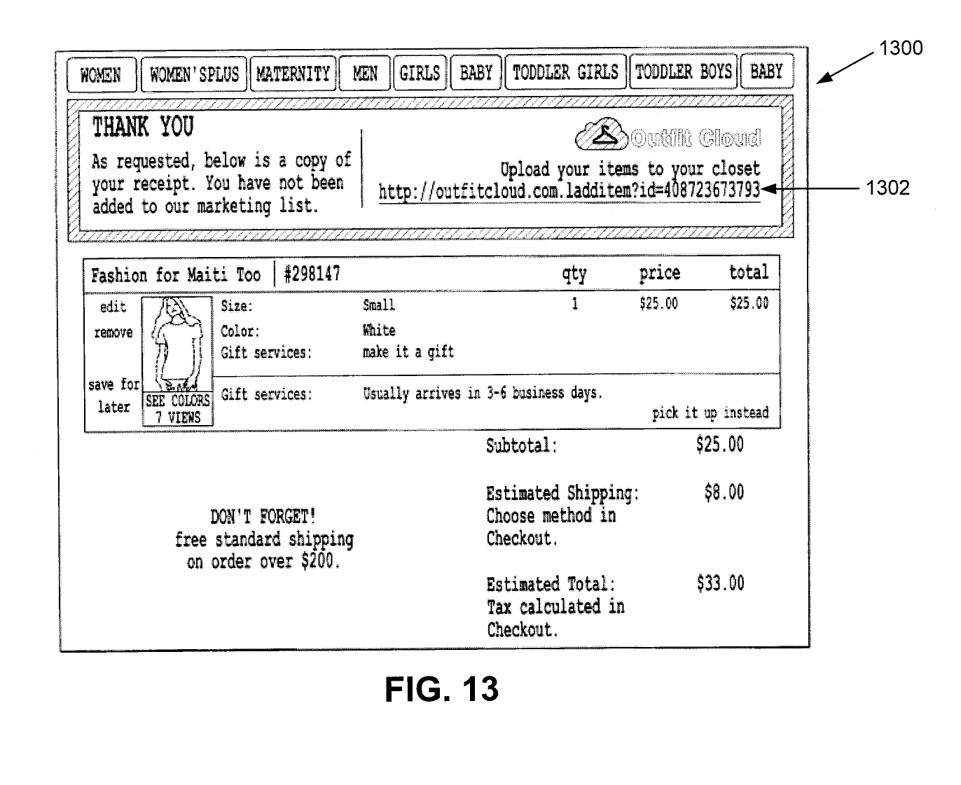

Referring to FIG. 12, in continuation from step S1106 of FIG. 11, when the payment is accepted (S1202), the online store's system confirms the transaction with a QR code generated to the transaction (S1216). Simultaneously, the system submits the transaction information to the social network 10 via API (S1232) and the database engine of the social network 10 assigns a unique identification number to the transaction, creates a unique link associated with the same transaction and returns to the member store's system (S1234). Subsequently, the store's system sends the user a confirmation email with an electronic receipt having the unique link on the receipt. FIG. 13 shows an illustrative electronic receipt with a unique link on the receipt according to an exemplary embodiment. At the upper right corner of the electronic receipt 1300 shown in FIG. 13, there is a link 1302 uniquely created to the transaction. Referring back to FIG. 12, when the payment is not accepted at step S1202, the online store's system asks if the buyer wants to try again with payment (S1204). If yes, the process goes back to step S1106. Otherwise, the process clears the list (S1206) and ends, and the store's system simultaneously submits a cancellation request to the social network 10 (S1208) and the information processing apparatus 100 destroys the list previously submitted by the store's system (S1210). Returning to step S1216, the store's system sends a confirmation email with the uniquely created link attached (S1218). After the shopping at the online store, the buyer can upload the purchased items to the purchase database 202 in various ways. In the first method, the buyer logs on to the social network 10 and uploads the purchased items to the purchase database 202 by way of entering the identification number uniquely created to the transaction. An alternative method is that the buyer can upload the purchased items to the purchase database 202 either by clicking on the link received in the confirmation email or by copying and pasting the uniquely created link in a web browser (S1220). Subsequently, the information processing apparatus 100 checks if the submitted QR code associated with the identification number or the link is valid at step S1222. If valid, the information processing apparatus 100 shows a success message (S1224) and ends the process. At the same time, the list of purchased items is linked to the buyer's profile and saved in the purchase database 202, and the QR code status is set as “used.” If the submitted QR code is not valid at step S1222, the information processing apparatus 100 shows a failure message (S1230) and returns to step S1220.

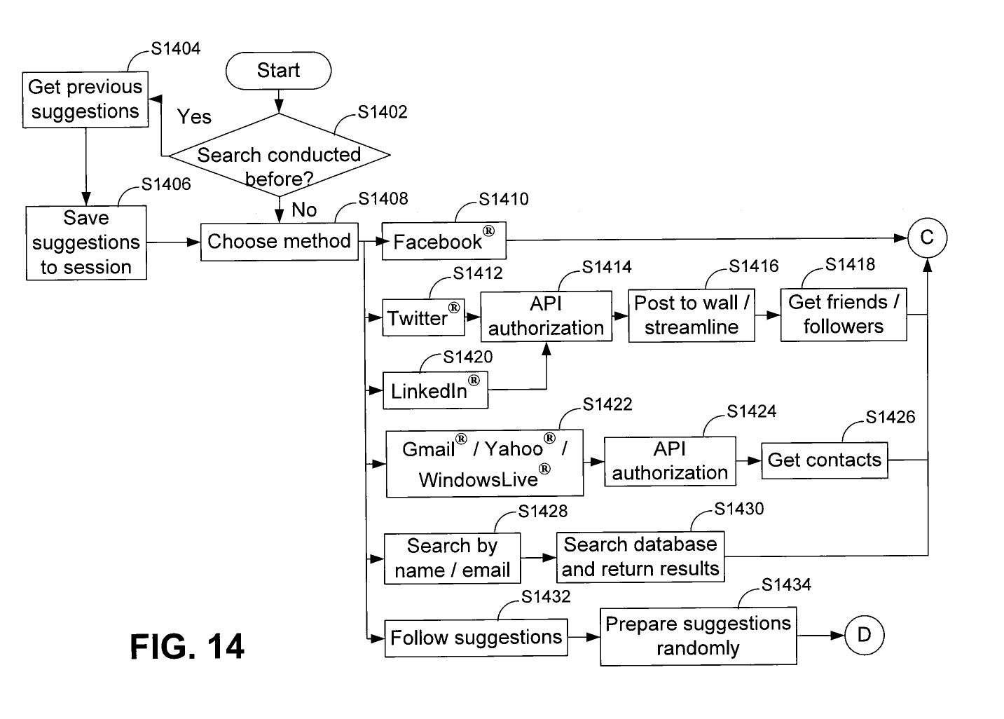

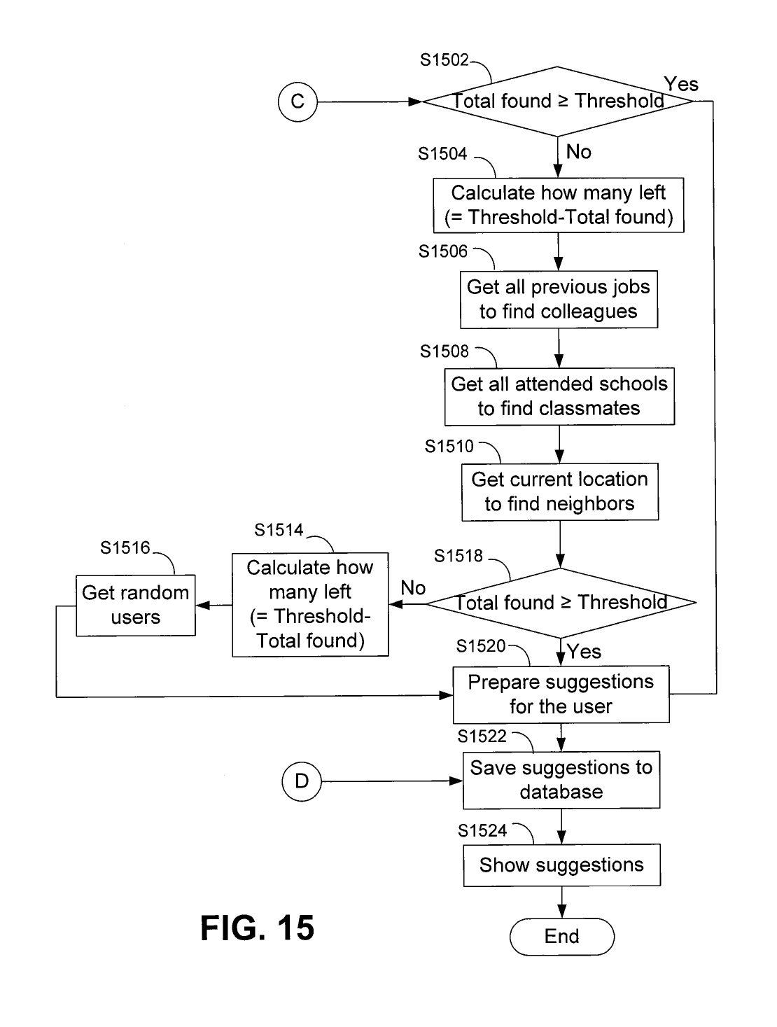

In an exemplary embodiment, the information processing apparatus 100 conducts one or more searches via other available social network sites such as Facebook®, Twitter®, and LinkedIn® or using other methods to find friends (or followers) of a user of the social network 10. Once one or more friends of the user are found, the profile and contact information of the friend is saved in correspondence with the user's profile in the user database 200. The search for friends can be conducted, for example, when there is a fashion style recommendations request to followers from a user of the social network 10 but the user currently has less followers than the minimum required number of followers that is set by the information processing apparatus 100. FIGS. 14 and 15 are algorithmic flow charts showing the process of finding friends or followers in the social network 10 according to an exemplary embodiment. Referring to FIG. 14, a search session starts by checking if there was one or more searches performed in the past with regard to the same user at step S1402. If yes, the previous search results including suggestions previously received are retrieved (S1404) from the history database 204 and saved to the search session (S1406) and proceeds to step S1408. Otherwise, the process directly goes to step S1408 where a search method is decided. For readily accessible social network sites that do not require API authorization, for example Facebook®, a search can be conveniently performed (S1410). On the other hand, for social network sites that require API authorization, for example Twitter® and LinkedIn® (S1412, S1420), API authorization is obtained first (S1414). Once obtained, the fashion style recommendations request from the user is posted to wall or streamline of respective site (S1416) and friends(or followers) are found in response to the posting (S1418). In case of other sites that require API authorization such Gmail®, Yahoo®, and WindowsLive® (S1422), once API authorization is obtained (S1424), contact information of friends are subsequently obtained (S1426). Alternatively, a search can be performed using the name or email address of the user (S1428) and the corresponding search results are saved (S1430). In case the search via the aforementioned methods is unsuccessful, the retrieved previous search results can be utilized (S1432) and suggestions are randomly generated based on the previous search results (S1434).

Next, once the search via the aforementioned methods is complete, a total of friends found who provided suggestions with regard to the user's request is compared with a threshold number set by the information processing apparatus 100, for example twenty friends. Referring to FIG. 15, when the number of the found friends who provide suggestions is equal to or more than the threshold number, the process skips to step S1520. Otherwise, the process calculates how many new friends still need to provide suggestions to achieve the threshold number at step S1504. Subsequently, the process continues to search for new friends using previous jobs of the user to find colleagues of the user (S1506), using the schools the user attended to find classmates of the user (S1508), and using a current location where the user lives to find neighbors of the user (S1510) and obtain suggestions from the friends found. When the threshold number is obtained (S1518), the process proceeds to step S1520. Otherwise, the process calculates how many new friends still need to provide suggestions to achieve the threshold number (S1514) and obtain suggestions from the corresponding number of random users of the social network 10 (S1516). At step S1520, based on the suggestions obtained from the friends found via the aforementioned methods, final suggestions for the user are prepared (S1520), saved in the history database 204 (S1522), and delivered to the user (S1524).

The information processing apparatus 100 of the present invention that includes the features in the foregoing description provides numerous advantages to users. In particular, the information processing apparatus 100 provides personalized fashion-related information. For example, the information processing apparatus 100 makes fashion style suggestions to each user on a daily basis like a personal stylist. Further, the information processing apparatus 100 recommends fashion items to purchase and delivers customized advertising to each user, which are sophisticatedly determined based on aggregate user's data (e.g. age, purchase history, location, weather, a view history on fashion items, preferred vendors, preferred brands). Thus, the user of the social network 10 can conveniently find fashion-related shopping information tailored to each user's needs without spending too much time in searching or asking about the needed information. In addition, the information processing apparatus 100 enables advertisers to better understand the needs of current and potential customers by providing statistical aggregate data of the users without disclosing the users' identity or personal information. Accordingly, the social network 10 promotes online advertising from businesses in fashion industry such as fashion item manufactures, vendors, retailers, and online shopping malls via the social network 10. the information processing apparatus 100 creates a unique identification number and assigns to a transaction made, thereby a user can conveniently upload purchased items to the social network 10. In case of online shopping, a unique link is generated and sent to the buyer, which makes it easier for the buyer to upload the purchased items to the social network 10.

The operation of the foregoing information processing apparatus 100 and steps performed in the exemplary flow charts provide a single embodiment of the apparatus and methodology of the present disclosure. One of ordinary skill in the art may optionally choose to perform all or a selected subset of the aforementioned steps, or may alternatively choose to perform the steps in a alternate order or to perform certain steps in parallel or series.

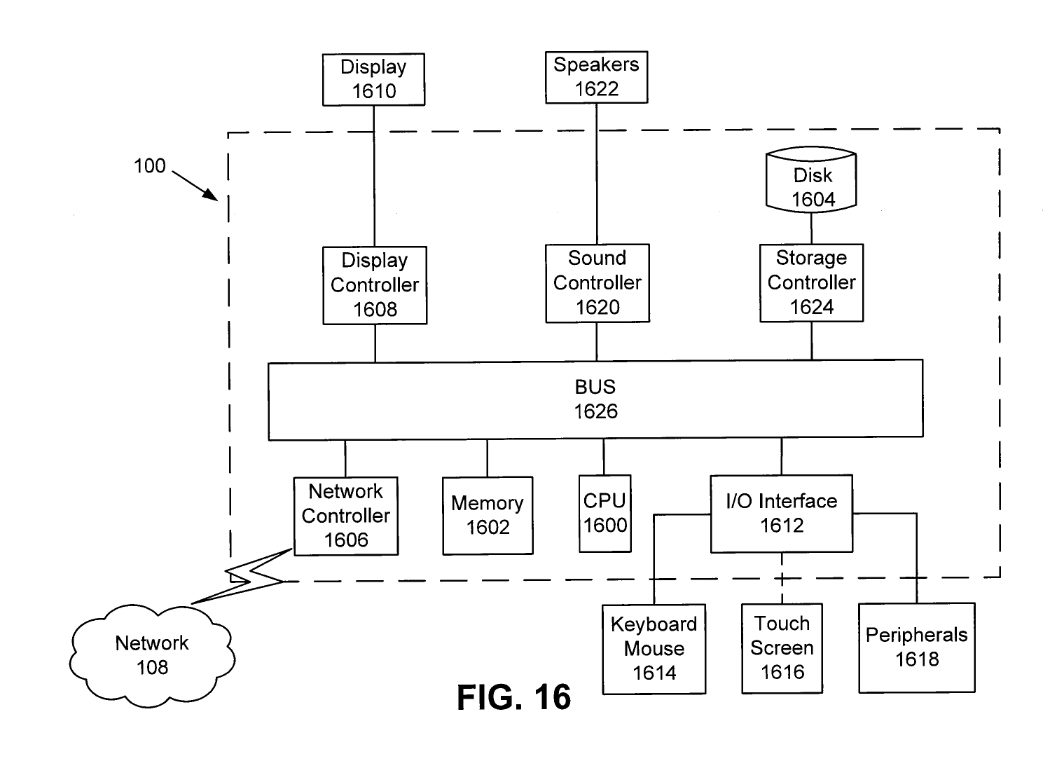

Next, FIG. 16 is a schematic diagram for hardware of the information processing apparatus 100 according to an exemplary embodiment. In FIG. 16, information processing apparatus 100 includes a CPU 1600 which performs the processes described above. The process data and instructions may be stored in memory 1602. These processes and instructions may also be stored on a storage medium disk 1604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer aided design station communicates, such as a server or computer.

Further, the claimed advancements may be provided as a utility application, background daemon, or component of an operating system, or combination thereof, executing in conjunction with CPU 1600 and an operating system such as Microsoft Windows 7, UNIX, Solaris, LINUX, Apple MAC-OS and other systems known to those skilled in the art.

CPU 1600 may be a Xenon or Core processor from Intel of America or an Opteron processor from AMD of America, or may be other processor types that would be recognized by one of ordinary skill in the art. Alternatively, the CPU 1600 may be implemented on an FPGA, ASIC, PLD or using discrete logic circuits, as one of ordinary skill in the art would recognize. Further, CPU 1600 may be implemented as multiple processors cooperatively working in parallel to perform the instructions of the inventive processes described above.

The information processing apparatus 100 in FIG. 16 also includes a network controller 1606, such as an Intel Ethernet PRO network interface card from Intel Corporation of America, for interfacing with network 108. As can be appreciated, the network 108 can be a public network, such as the Internet, or a private network such as an LAN or WAN network, or any combination thereof and can also include PSTN or ISDN sub-networks. The network 108 can also be wired, such as an Ethernet network, or can be wireless such as a cellular network including EDGE, 3G, and 4G wireless cellular systems. The wireless network can also be WiFi, Bluetooth, or any other wireless form of communication that is known.

The information processing apparatus 100 further includes a display controller 1608, such as a NVIDIA GeForce GTX or Quadro graphics adaptor from NVIDIA Corporation of America for interfacing with display 1610, such as a Hewlett Packard HPL2445w LCD monitor. A general purpose I/O interface 1612 interfaces with a keyboard and/or mouse 1614 as well as a touch screen panel 1616 on or separate from display 1610. General purpose I/O interface also connects to a variety of peripherals 1618 including printers and scanners, such as an OfficeJet or DeskJet from Hewlett Packard.

A sound controller 1620 is also provided in the information processing apparatus 100, such as Sound Blaster X-Fi Titanium from Creative, to interface with speakers/microphone 1622 thereby providing sounds and/or music. The speakers/microphone 1622 can also be used to accept dictated words as commands for controlling the information processing apparatus 100 or for providing location and/or property information with respect to the associated websites.

The general purpose storage controller 1624 connects the storage medium disk 1604 with communication bus 1626, which may be an ISA, EISA, VESA, PCI, or similar, for interconnecting all of the components of the information processing apparatus 100. A description of the general features and functionality of the display 1610, keyboard and/or mouse 1614, as well as the display controller 1608, storage controller 1624, network controller 1606, sound controller 1620, and general purpose I/O interface 1612 is omitted herein for brevity as these features are known.

Obviously, numerous modifications and variations of the present invention are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1: An information processing apparatus for generating personalized fashion-related information and promoting online advertising for users of a social network, the apparatus comprising:
a user database that stores profile information of one or more users of the social network and relationship data between each user and followers of each user;
a purchase database that stores purchase information of each user in correspondence with respective profile information of the each user;
a history database that stores history information of each user of the social network including a purchase history from the purchase database; and
a processor programmed to
receive purchase information of a first user in response to a purchase made off-line in a vendor store or via an online vendor store by the first user by receiving a post-purchase approval from the first user,
store the purchase information in the purchase database with respect to the first user in response to receiving the post-purchase approval,
generate personalized fashion-related information for the first user based on the profile information and history information of the first user,
determine one or more types of advertising to be provided to the first user based on the profile information and history information of the first user, and
serve to the first user the generated personalized fashion-related information and the determined types of advertising,
wherein, when the purchase is made off-line in a vendor store and upon acceptance of payment of the purchase,
a unique identification number included on a vendor receipt is assigned to the purchase, and
the post-purchase approval is performed by way of receiving the unique identification number or a barcode being scanned via a mobile device from the vendor receipt, and
wherein, when the purchase is made via an online vendor store and upon acceptance of payment of the purchase,
a unique identification number is assigned to the purchase and a unique link associated with the purchase is created, the unique identification number and the unique link being sent to the first user, and
the post-purchase approval is performed via activation of the unique link.

2: The information processing apparatus according to claim 1, wherein the processor is further programmed to receive styling suggestions from followers of the first user in response to the first user posting a fashion recommendation request to the followers of the first user, and to transmit the received styling suggestions to the first user.

3: The information processing apparatus according to claim 2, wherein the processor is further programmed to generate the personalized fashion-related information for the first user based on local weather information where the first user is located and the styling suggestions received from the followers of the first user.

4: The information processing apparatus according to claim 1, wherein the profile information includes age, gender, body measurements, a budget, and a geographic location of the each user.

5: The information processing apparatus according to claim 1, wherein the purchase information includes a user identification number of the each user making a purchase, a description of a purchased item, a brand name, a vendor name, and a geographic location and weather information where the purchase is made.

6: The information processing apparatus according to claim 1, wherein the history information further includes a history of viewed items, a history of preferred vendors, and a history of preferred brands.

7: The information processing apparatus according to claim 3, wherein the personalized fashion-related information includes a list of recommended fashion-related items for purchase and a list of recommended vendors of the fashion-related items.

8: The information processing apparatus according to claim 1, wherein the processor provides recommendations to users of the social network to follow one or more style preferences of another user having one or more common style preferences with the respective user, the style preferences being determined based on the profile and history information of the another user.

9: The information processing apparatus according to claim 7, wherein, in process of determining the recommended fashion-related items for purchase, the processor is further programmed to consider gender of the first user and a current local weather of the first user.

10: The information processing apparatus according to claim 9, wherein, in process of determining the recommended fashion-related items for purchase, the processor is further programmed to consider previous purchases of the first user from the history database.

11: The information processing apparatus according to claim 1, wherein the processor determines the advertising to be provided to the first user without disclosing identity of the first user by not sharing the profile information of the first user with an advertiser providing the advertising to the first user.

12: The information processing apparatus according to claim 2, wherein the processor is further programmed to conduct a search via network sites other than the social network to find new followers when the number of the received styling suggestions from the followers of the first user is less than a predetermined threshold.

13: An information processing method, implemented by one or more servers, for generating personalized fashion-related information and promoting online advertising for users of a social network, comprising:
storing, in a user database, profile information of one or more users of the social network and relationship data between each user and followers of each user;
receiving, at the one or more servers, purchase information of a first user in response to a purchase made off-line in a vendor store or via an online vendor store by the first user by receiving a post-purchase approval from the first user;
storing, at the one or more servers, the purchase information in the purchase database with respect to the first user in response to receiving the post-purchase approval;
storing, at the one or more servers, history information of the first user in a history database including a purchase history from the purchase database;
generating, at the one or more servers, personalized fashion-related information for the first user based on the profile information and history information of the first user;
determining, at the one or more servers, one or more types of advertising to be provided to the first user based on the profile information and history information of the first user; and
serving, via the one or more servers, to the first user the generated personalized fashion-related information and the determined types of advertising,
wherein, when the purchase is made off-line in a vendor store, upon acceptance of payment of the purchase,
a system of the vendor store submits purchase information to the social network;
a database engine of the social network assigns to the purchase a unique identification number to be included on a vendor receipt; and
the post-purchase approval is performed by way of receiving the unique identification number or a barcode being scanned via a mobile device from the vendor receipt, and
wherein, when the purchase is made via an online vendor store, upon acceptance of payment of the purchase,
a system of the online vendor store submits purchase information to the social network;
the database engine of the social network assigns to the purchase a unique identification number and create a unique link associated with the purchase, both the unique identification number and the unique link being to be included in a confirmation email to be sent to the first user; and
the post-purchase approval is performed by way of receiving the unique identification number or the unique link being clicked.

14: A non-transitory computer-readable medium having computer-readable instructions stored therein for generating personalized fashion-related information and promoting online advertising for users of a social network that when executed by a computer causes the computer to perform a method comprising:
storing profile information of one or more users of the social network and relationship data between each user and followers of each user in a user database;
receiving purchase information of a first user in response to a purchase made off-line in a vendor store or via an online vendor store by the first user by receiving a post-purchase approval from the first user;
storing the purchase information in the purchase database with respect to the first user in response to receiving the post-purchase approval;
storing history information of the first user in a history database including a purchase history from the purchase database;
generating personalized fashion-related information for the first user based on the profile information and history information of the first user;
determining one or more types of advertising to be provided to the first user based on the profile information and history information of the first user; and
serving to the first user the generated personalized fashion-related information and the determined types of advertising,
wherein, when the purchase is made off-line in a vendor store, upon acceptance of payment of the purchase,
a system of the vendor store submits purchase information to the social network;
a database engine of the social network assigns to the purchase a unique identification number to be included on a vendor receipt; and
the post-purchase approval is performed by way of receiving the unique identification number or a barcode being scanned via a mobile device from the vendor receipt, and
wherein, when the purchase is made via an online vendor store, upon acceptance of payment of the purchase,
a system of the online vendor store submits purchase information to the social network;
the database engine of the social network assigns to the purchase a unique identification number and create a unique link associated with the purchase, both the unique identification number and the unique link being to be included in a confirmation email to be sent to the first user; and
the post-purchase approval is performed by way of receiving the unique identification number or the unique link being clicked.
